(19) United States
(12) Patent Application Publication
(10) Pub. No.: US 2003/0053446 A1
(43) Pub. Date: Mar. 20, 2003

(54) Public telecommunication terminal used for both of pstn telephony and voip telephony and method for controlling thereof

(76) Inventor: Hwang-Sub Kwon, Seoul (KR)

Correspondence Address: DANN DORFMAN HERRELL & SKILLMAN, SUITE 720, 1601 MARKET STREET, PHILADELPHIA, PA, 19103-2307, US

(21) Appl. No.: 10/247,607

(22) Filed: Sep. 18, 2002

(30) Foreign Application Priority Data
Sep. 20, 2001 (KR) 58320/2001

(51) Int. Cl. H04L 12/66

(52) U.S. Cl. 370/352; 379/88.17; 379/900

(57) ABSTRACT

A public telecommunication terminal used for both of PSTN telephony and VoIP telephone and a method of controlling thereof are disclosed. When a user takes a handset, a dial tone is generated, and a dial tone corresponding to a number the user dials is generated and outputted. When a telephone call completion button is selected, the dialed number is transmitted to the Internet in the form of data packet. The public telecommunication terminal checks if the Internet is available, and it is automatically converted into PSTN mode when the Internet is not available.

### BACKGROUND OF THE INVENTION

1. Field of the Invention

The present invention relates to a public telecommunication terminal used for both of PSTN (Public Switched Telephone Network) telephony and VoIP (Voice over Internet Protocol) telephony and a method for controlling thereof, more specifically, a public telecommunication terminal and a method for controlling thereof, capable of selectively employing PSTN or VoIP function to allow its user to be able to use long-distance and international telephone calls at a low telephone charges.

2. Background of the Related Art

The traditional telephony service business was monopolized by a common carrier having wired networks and wireless networks, such as Korea Telecomm, so that there is no competitor. Accordingly, telephone subscribers and public telecommunication terminal users have no choice but to pay telephone charges the common carrier fixes.

However, with the striking development of information communication industry and computer technology, the Internet becomes popularized and the number of Internet-related common carriers is being increased. Further, as Internet-related businesses are activated, users can be provided with high quality communication infrastructure and a variety of services.

With actualization of telephony businesses using the Internet, especially, telephony using the Internet (VoIP) becomes available. In addition, common carriers provide various services and propose low telephone charges as VoIP-dedicated telephone handsets are launched, to allow telephone subscribers or users to have a wide choice. Accordingly, the telephone charges exclusively fixed by a specific common carrier can be checked.

However, the conventional VoIP-dedicated telephone handset has the following problems.

First of all, the manufacturing cost of the VoIP-dedicated telephone handset is expensive according to various protocols so that general users cannot readily purchase to use it. Even if they buy the telephone handset to use, they cannot make a phone call when the Internet is in a disconnection state due to various causes.

Further, in case where a user wants to use VoIP (Voice over Internet Protocol), he should lease a line to connect his VoIP-dedicated telephone handset with the Internet. In such a case, the user must pay charges for leasing the line, such as a monthly flat rate, for a predetermined lease period after he leases it irrespective of whether he makes a phone call or not. In addition, the VoIP-dedicated telephone handset does not sound a dial tone because it is not connected in real time, distinguished from the traditional telephone handset. Accordingly, a user accustomed to the traditional telephone handset may mistakenly recognize the VoIP telephone sounding no dial tone to be in the disconnection state.

### SUMMARY OF THE INVENTION

An object of the present invention is to provide a public telecommunication terminal that can selectively employ PSTN or VoIP function to allow its user to be able to use long-distance and international telephone calls at low telephone charges and to popularize VoIP telephony.

Another object of the present invention is to provide a method of controlling the aforementioned public telecommunication terminal used for both of PSTN telephony and VoIP telephony.

To accomplish the objects of the present invention, there is provided a public telecommunication terminal performing a PSTN mode using a telephone network and a VoIP mode using the Internet, comprising an input part having a plurality of function keys through which various functions of the public telecommunication terminal are selected or telephone numbers are inputted; a display device for displaying a variety of operations of the public telecommunication terminal and information inputted through the input part; a modem for connecting the public telecommunication terminal with the telephone network or the Internet such that they can communicate with each other; a verifying means for verifying a payment means; a handset for converting a voice signal of a user into an electric signal or converting a voice signal of a called party into real sound; a hook switch that is switched according to the operation of the handset; a central controller for converting a voice signal inputted through the handset into voice data and converting voice data received through the Internet into a voice signal in the VoIP mode; and a telephone controller for transmitting a signal received from the handset to the central controller in the VoIP mode, and delivering a signal received from the handset to the modem to control the modem to connect with the telephone network in the PSTN mode.

The verifying means preferably includes a card reader for judging the kind of a card the user puts in and detecting information of the card to transmit it to the telephone controller; and a coin sorter for sorting the kinds of coins the user puts in and transmitting it to the telephone controller.

It is preferable that the central controller includes a central processing unit for controlling the operations of the input part and the display device, analyzing information inputted through the input part, and detecting a telephone call dial tone and a voice signal of dialing tone from the analyzed input information to output them; a memory for storing a variety of programs to be executed by the central processing unit, storing temporary data generated while the central processing unit is executing a program, and storing the telephone call dial tone data and dialing tone data corresponding to each numeral key; a voice signal processing circuit for digitalizing a voice signal inputted through a microphone of the handset to transmit it to the Internet, and converting a digital voice signal of a called party, received through the Internet, into an analog signal to deliver it to the handset; and a voice signal compression module for compressing a digital voice signal outputted from the voice signal processing circuit using a predetermined compression method, and decompressing a compressed voice signal received through the Internet.

The memory preferably stores a called party s telephone number the user inputs through the input part when the VoIP mode is performed, and the central processing unit detects the called party s telephone number stored in the memory to transmit it in the form of packet when dialing is completed.

The input part may further have a dialing completion button by which completion of dialing the phone number of the called party is selected.

The central processing unit may recognize that dialing is completed if the dialing completion button of the input part is selected by the user.

The central processing unit may recognize that dialing is completed when a signal is not inputted from the input part for a predetermined period of time.

The input part can further has a predetermined environment setting button through which the public telecommunication terminal is set to the PSTN mode or VoIP mode.

It is preferable that the telephone controller includes a microcontroller for managing the telephone controller; an interface for controlling communication between the verifying means and the microcontroller; a communication circuit for interfacing communication between the microcontroller and the central processing unit; a speaking circuit for transmitting/receiving a voice signal inputted/outputted through the handset to/from the telephone network; relay switches that are switched to transmit a voice signal inputted/outputted through the handset to one of the speaking circuit and the voice signal processing circuit; and relay part for controlling the switching operations of the relay switches under the control of the microcontroller.

The relay part preferably includes a relay for controlling contact states of the relay switches; and a switching element that is turned on/off according to the control of the microcontroller so as to control flow of constant voltage, to control magnetized state of the relay.

The central controller preferably confirms if the Internet is available or not and, when the Internet is available, converts the terminal into the VoIP mode, the central controller unit converting the terminal into the PSTN mode when the Internet is not available.

To accomplish the objects of the present invention, there is also provided a method for controlling a public telecommunication terminal that is connected with a telephone network and the Internet through a modem and performs a PSTN mode using the telephone network and a VoIP mode using the Internet, the method comprising the steps of checking the state of the modem when a handset is hooked off, to confirm if connection between the public telecommunication terminal and the Internet is available; generating and outputting a predetermined dial tone when the connection is available; when a phone number is dialed, generating and outputting a tone signal corresponding to the dialed number using a predetermined tone signal generating means; transmitting a packet of the dialed number to the Internet upon the completion of the dialing; and converting into the PSTN mode when the connection is not available.

It is preferable that it is judged if the current mode is the PSTN mode when the connection to the Internet is available, and the public telecommunication terminal is converted into the PSTN mode irrespective of whether the connection is available or not when the PSTN mode is set.

Dialing is judged to be completed or not according as a dialing completion button is selected or not. Otherwise, it is judged that dialing is completed when there is no input for a predetermined period of time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a configuration of a network of a public telecommunication terminal system used for both of PSTN telephony and VoIP telephony according to the present invention;

FIG. 2 is a block diagram of the public telecommunication terminal shown in FIG. 1;

FIG. 3 is a detailed block diagram of the public telecommunication terminal shown in FIG. 1; and

FIG. 4 is a flow diagram showing the operation of the public telecommunication terminal used for both of PSTN and VoIP telephony according to the present invention.

### DETAILED DESCRIPTION OF THE INVENTION

Reference will now be made in detail to the preferred embodiments of the present invention, examples of which are illustrated in the accompanying drawings.

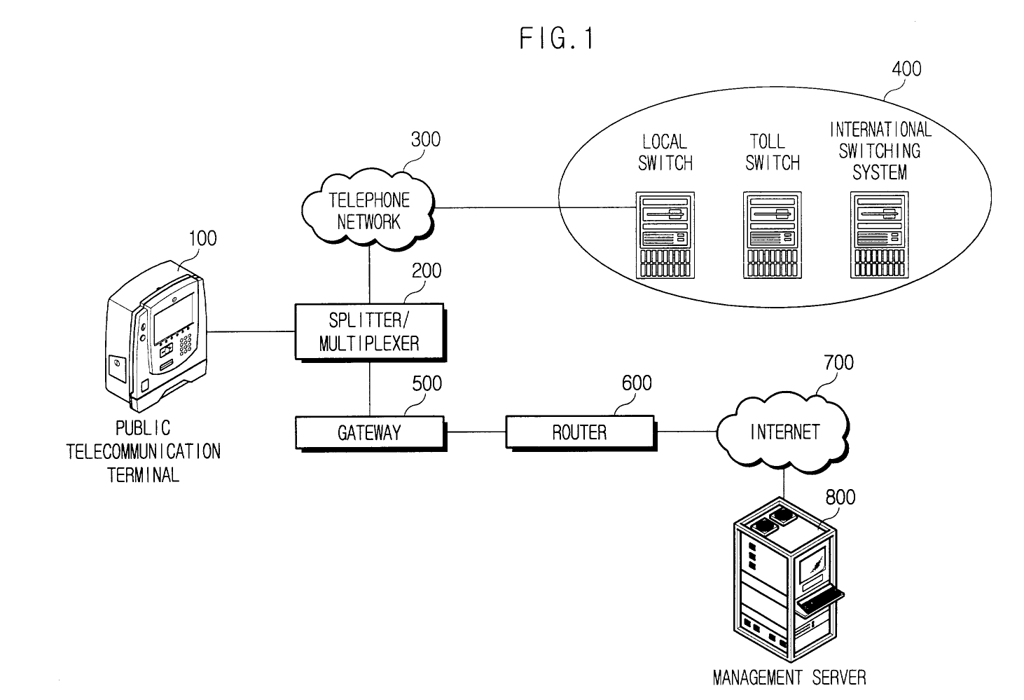

Referring to FIG. 1, a public telecommunication terminal 100 according to the present invention provides PSTN and VoIP telephone functions. Accordingly, the terminal 100 includes a multiplexer capable of mixing a voice signal and voice data with each other to transmit.

A splitter/multiplexer 200 separates the voice signal and voice data transmitted from the public telecommunication terminal 100 from each other, delivers the separated voice signal to a switching system (local switch, toll switch and international switching system) 400 through a telephone network 300 and sends the voice data to the Internet 700 via a gateway 500 and a router 600. A management server 800 is connected with the Internet 700 to transmit the voice data delivered from the public telecommunication terminal 100 to the telephone of a called party.

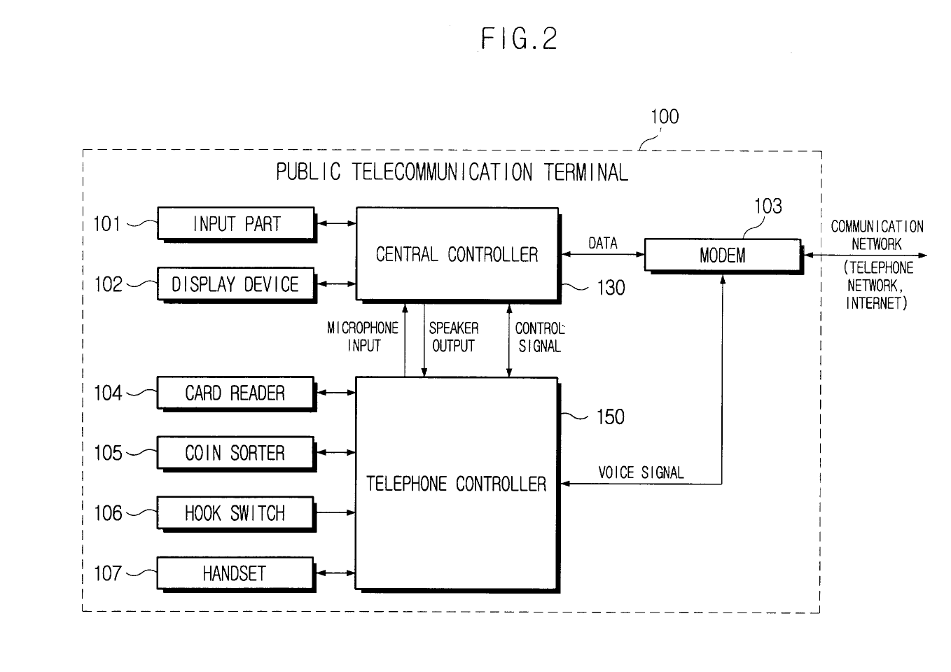

The configuration of the public telecommunication terminal 100 is explained with reference to FIG. 2. An input part 101 is configured of a plurality of function keys by which the public telecommunication terminal's user can select various functions of the terminal 100 or input a telephone number. Especially, the input part 101 includes a dialing completion button through which the user can select completion of dialing personally, and an environment setting button by which conversion between modes of the public telecommunication terminal, PSTN mode and VoIP mode, is carried out.

A display device 102 displays various operations of the public telecommunication terminal 100 and input information of a user. A modem 103 connects the public telecommunication terminal to a communication network (including the telephone network 300 and the Internet 700) to make telecommunication available when the user wants to use PSTN or VoIP service using the public telecommunication terminal 100.

A card reader 104 judges the kind of a card the user puts in and detects information of the card. A coin sorter 105 sorts the kinds of coins inserted by the user. Here, the card reader 104 and the coin sorter 105 correspond to verifying means of charge payment means (that is, card and coin).

A hook switch is switched by the user s operation of a handset 107, to allow a telephone controller 150 to be able to recognize the telephone mode. The handset 107 converts a voice signal of the user into an electric signal or converts a voice signal of a called party into real sound when the user is talking over the telephone.

A central controller 130 controls the operations of the input part 101, display device 102 and modem 103 and, simultaneously, analyzes signals inputted through the input part 101 and modem 103. In addition, the central controller 130 converts a voice signal inputted through the handset 107 into data to output it through the modem 103 when VoIP telephone function is performed.

The telephone controller 150 controls the operations of the card reader 104, coin sorter 105, hook switch 106 and handset 107 and, simultaneously, transmits signals inputted through the card reader 104 and handset 107 to the central controller 130.

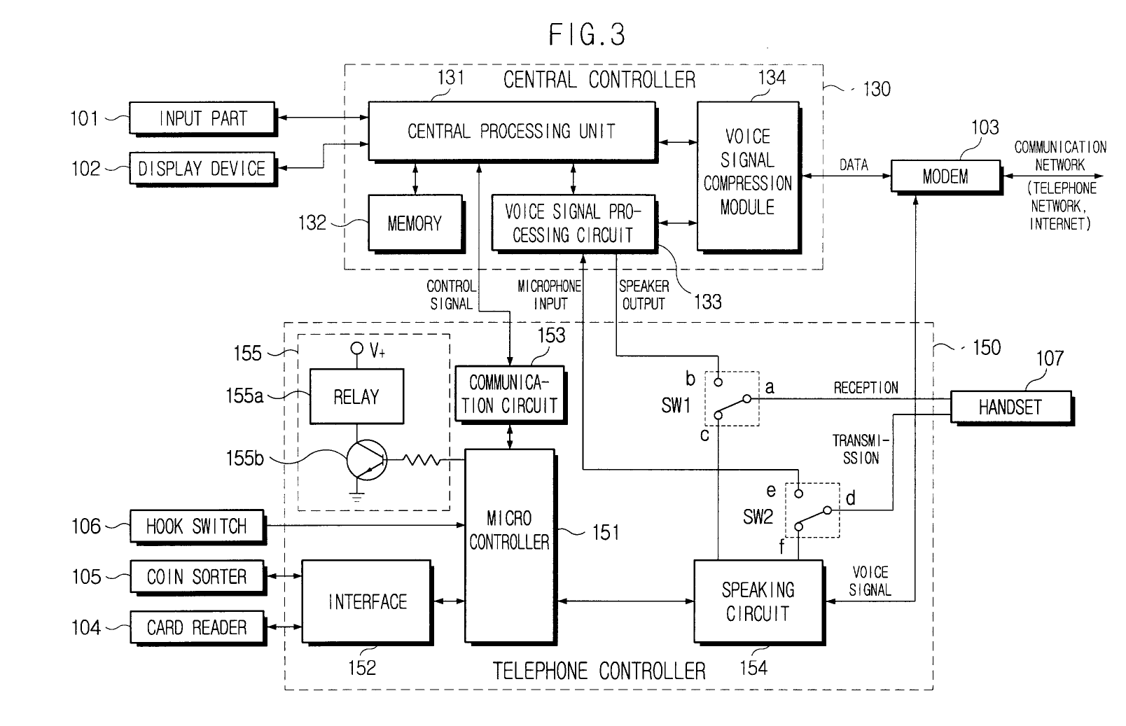

Next, the detailed configuration of the public telecommunication terminal 100 shown in FIG. 2 is described with reference to FIG. 3. The central controller 130 includes a central processing unit 131 for controlling the operations of the input part 101 and display device 102, a memory 132 for storing a variety of programs to be executed by the central processing unit 131 and temporary data generated while the central processing unit 131 executes a program, a voice signal processing circuit 133 for digitalizing a voice signal inputted from a microphone of the handset 107 to transmit it to the Internet 700 and for converting a digital voice signal of a called party, received through the Internet 700, into an analog signal to send it to the handset 107, and a voice signal compression module 134 for compressing a digital voice signal outputted from the voice signal processing circuit 133 with a predetermined compression method and decompressing a compressed voice signal received through the Internet 700. Here, the memory 132 stores telephone call dial tone data and dialing tone data corresponding to each numeral key, and temporarily stores the telephone number of a called party, inputted by a user, when VoIP mode is carried out.

The telephone controller 150 includes a microcontroller 151 for managing the telephone controller 150, an interface 152 for controlling communication among the card reader 104, coin sorter 105 and microcontroller 151, a communication circuit 153 for interfacing communication between the microcontroller 151 and central processing unit 131, a speaking circuit 154 for transmitting/receiving a voice signal inputted/outputted through the handset 107 to/from the telephone network 300, relay switches SW1 and SW2 that are switched to transmit the voice signal inputted/outputted through the handset 107 to one of the speaking circuit 154 and voice signal processing circuit 133, and a relay part 155 for controlling the switching operations of the relay switches SW1 and SW2 under the control of the microcontroller 151.

Here, the relay part 155 is constructed of a relay 155a for controlling the contact state of the relay switches SW1 and SW2, and a switching element 155b (transistor, for example) that is turned on or off under the control of the microcontroller 151 so as to control flow of constant voltage (V+) and controls the magnetized state of the relay 155a.

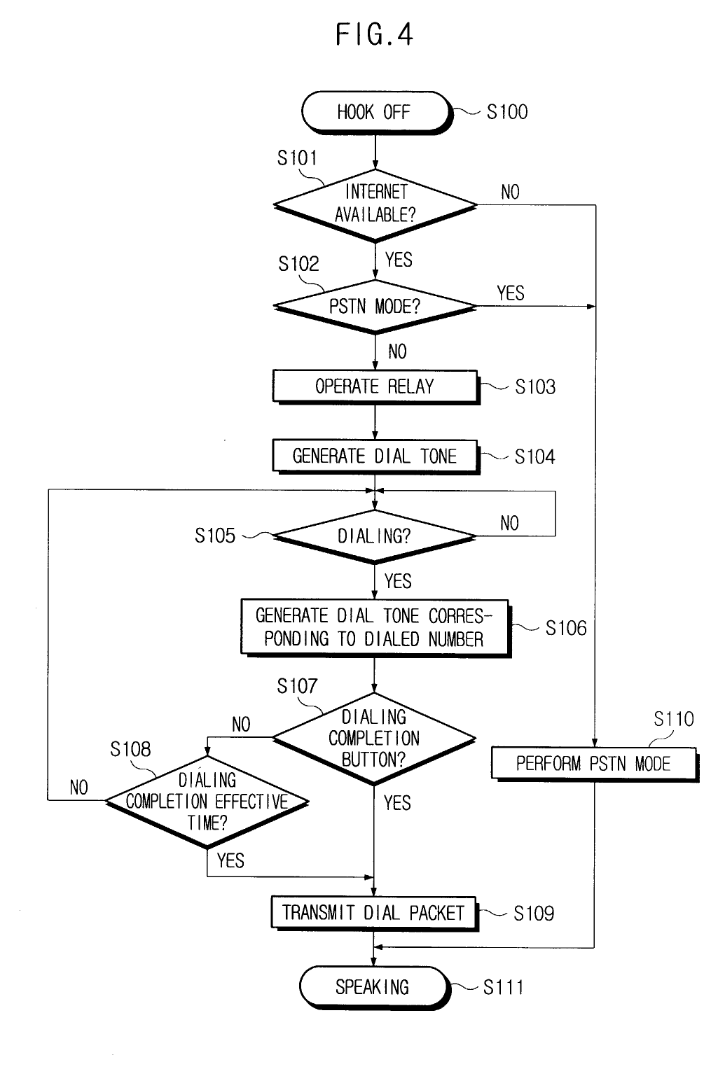

The operation of the public telecommunication terminal having the aforementioned configuration according to the present invention is explained below with reference to FIG. 4.

First of all, the central controller 130 checks data state of the modem 103 in standby state, to judge if the Internet 700 is in a normally available state or not. Here, when the central controller 130 judges that the Internet 700 is not available, it performs PSTN mode in which telephone call is made using the telephone network 300.

VoIP Mode

When a user takes the handset 107, the hook switch 106 operates (S100) and accordingly the microcontroller 151 of the telephone controller 150 is converted into a telephone utilization mode. Here, when the microcontroller 151 receives a notice informing that the Internet 700 is available from the central controller 130 through the communication circuit 153 (S101), it operates the relay part 155 (S103). Upon the operation of the relay part 155, contacts a-b and d-e of the relay switches SW1 and SW2 become their contact states, respectively, to set up a state in which the user can use VoIP telephone.

Thereafter, when the user puts payment means (card, coin and the like) in the terminal in order to pay charges for using the telephone, the card reader 104 and coin sorter 105 transmit a signal with respect to the inserted card or coin to the microcontroller 151 via the interface 152. The microcontroller 151 judges if the total amount of inserted coin or the balance of the card exceeds a basic rate. When it exceeds the basic rate, the microcontroller 151 requests the central processing unit 131 of the central controller 130 through the communication circuit 153 to transmit a dial tone. Here, the central processing unit 131 extracts the dial tone data stored in the memory 132 to provide it to the voice signal processing circuit 133. The voice signal processing circuit 133 converts the dial tone data into an analog dial tone and outputs it through the handset 107 (S104). Accordingly, the user can hear a dial tone similar to that generated by a general PSTN switching system through the handset 107.

Subsequently, when the user operates the dial buttons of the input part 101 to dial the phone number of a called party (S105), the number inputted through the input part 101 is instantaneously transmitted to the central processing unit 131. The central processing unit 131 temporarily stores the inputted number and, simultaneously, analyzes it, and then extracts information corresponding to the number from the memory 132 to send it to the voice signal processing circuit 133. The voice signal processing circuit 133 converts the information corresponding to the inputted number into an analog signal to deliver it to the handset 107 (S105). Accordingly, a dial tone corresponding to the number inputted by the user is outputted through the handset 107 so that the user can hear the tone.

In call processing procedures of VoIP telephony and PSTN telephony, the public telecommunication terminal 100 itself automatically generates a simulation tone to provide the same environment as that of the PSTN telephony because VoIP does not create a dial tone. In other words, all of operations in call processing are carried out in real time after the public telecommunication terminal 100 is connected with the switching system in the PSTN telephony whereas all data is transmitted in the form of packet in the VoIP telephony. Accordingly, it is required that users accustomed to the public telecommunication terminal having the general PSTN telephone function are provided with the same environment as that of the PSTN telephony to mitigate rejection symptom or confusion of the users.

Upon the completion of dialing, the user selects the dialing completion button of the input part 101 (S107), and the central processing unit 132 extracts telephone number data stored in the memory 132 and compresses it using a predetermined compression method in the voice signal compression module 134 to transmit it to the modem 103. The modem 103 delivers the telephone number data sent from the voice signal compression module 134 to the Internet 700 (S109).

In case where the user does not select the dialing completion button in the above-described step (S107), the central processing unit 131 starts counting from the point of time at which each button is pushed by the user and, when the counted time exceeds a predetermined period of time (five seconds, for example) (S108), judges it as completion of dialing to perform the same procedure as the procedure carried out when the dial completion button is selected. Accordingly, the user can be provided with VoIP telephone service using the public telecommunication terminal 100.

PSTN Mode

In order for the public telecommunication terminal 100 to execute the PSTN mode, the public telecommunication terminal 100 is set to the PSTN mode through the input part 101 in a terminal setting mode at the first stage (S102). Then, the central processing unit 131 stores information about mode conversion in the memory 132 and maintains the PSTN mode until the mode is changed. Specifically, the central processing unit 131 informs the microcontroller 151 of the information about mode conversion through the communication circuit 153 of the telephone controller 150 to allow the microcontroller 151 not to operate the relay part 155. At this time, the relay switches SW1 and SW2 maintain contact states of contacts a-c and d-f.

Further, when the central processing unit 131 judges that the Internet 700 is not available at the initial stage, the PSTN mode is automatically performed irrespective of environment setting until the Internet 700 becomes available even if the current mode is set to VoIP mode (S110).

When the user takes the handset 107 in the PSTN mode, the hook switch 106 operates and accordingly the microcontroller 151 of the telephone controller 150 is converted into the telephone utilization mode. Here, since the contacts a-c and d-f of the relay switches SW1 and SW2 are in their contact states, the user can use PSTN telephone.

Thereafter, when the user puts payment means (card, coin and the like) in the terminal in order to pay charges for using the telephone, the card reader 104 and coin sorter 105 transmit a signal with respect to the inserted card or coin to the microcontroller 151 via the interface 152. The microcontroller 151 judges if the total amount of inserted coin or the balance of the card exceeds a basic rate for making a phone call. When it exceeds the basic rate, the microcontroller 151 controls the speaking circuit 154. Accordingly, the speaking circuit 154 occupies the switching system 400 of the telephone network 300 through the modem 103. At this time, when the switching system 400 generates and outputs a dial tone, this dial tone is delivered through the modem 103 and speaking circuit 154 to be outputted through the handset 107. Accordingly, the user can hear the dial tone through the handset 107.

Subsequently, the user operates the dial buttons of the input part 101 to dial the phone number of a called party, the number inputted through the input part 101 is transmitted through the central processing unit 131, communication circuit 153, microcontroller 151, speaking circuit 154, and modem 103 to the telephone network 300 and switching system 400. When the switching system 400 calls the called party's phone number, the public telecommunication terminal 100 is converted into a speaking available state and accordingly the user can speak with the called party (S11).

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

The public telecommunication terminal used for both of PSTN telephony and VoIP telephony and the method for controlling thereof according to the present invention have the following advantages.

First, there is no need for a telephone subscriber to purchase an expensive VoIP telephone terminal in order to use VoIP telephone. In addition, the subscriber can make long-distance and international phone calls at reduced telephone charges by using VoIP because he pays only charges for actual speaking time.

Furthermore, even in case where the Internet is not available, the public telecommunication terminal according to the invention can make a phone call through PSTN so that continuity failure of telephone can be prevented in advance.

Moreover, VoIP function is added to the public telecommunication terminal to allow whoever wants to be able to use it conveniently, and various payment means (card, coin and the like) are employed so that users can pay charges for using telephone with convenience. Further, the user can hear the same dial tone as that of the PSTN telephone even when he makes a phone call using the Internet. This solves the problem of the conventional VoIP telephone that the user mistakenly recognizes the VoIP phone sounding no dial tone to be in continuity failure. Accordingly, utilization of the terminal used for PSTN and VoIP can be promoted.

What is claimed is:

1. A public telecommunication terminal performing a PSTN mode using a telephone network and a VoIP mode using the Internet, comprising:
an input part having a plurality of function keys through which various functions of the public telecommunication terminal are selected or telephone numbers are inputted;
a display device for displaying a variety of operations of the public telecommunication terminal and information inputted through the input part;
a modem for connecting the public telecommunication terminal with the telephone network or the Internet such that they can communicate with each other;
a verifying means for verifying a payment means;
a handset for converting a voice signal of a user into an electric signal or converting a voice signal of a called party into real sound;
a hook switch that is switched according to the operation of the handset;
a central controller for converting a voice signal inputted through the handset into voice data and converting voice data received through the Internet into a voice signal in the VoIP mode; and
a telephone controller for transmitting a signal received from the handset to the central controller in the VoIP mode, and delivering a signal received from the handset to the modem to control the modem to connect with the telephone network in the PSTN mode.

2. The public telecommunication terminal according to claim 1, wherein the verifying means comprises:
a card reader for judging the kind of a card the user puts in and detecting information on the card to transmit it to the telephone controller; and
a coin sorter for sorting the kinds of coins the user puts in and transmitting it to the telephone controller.

3. The public telecommunication terminal according to claim 1, wherein the central controller comprises:
a central processing unit for controlling the operations of the input part and the display device, analyzing information inputted through the input part, and detecting a telephone call dial tone and a voice signal of dialing tone from the analyzed input information to output them;
a memory for storing a variety of programs to be executed by the central processing unit, storing temporary data generated while the central processing unit is executing a program, and storing the telephone call dial tone data and dialing tone data corresponding to each numeral key;
a voice signal processing circuit for digitalizing a voice signal inputted through a microphone of the handset to transmit it to the Internet, and converting a digital voice signal of a called party, received through the Internet, into an analog signal to deliver it to the handset; and
a voice signal compression module for compressing a digital voice signal outputted from the voice signal processing circuit using a predetermined compression method, and decompressing a compressed voice signal received through the Internet.

4. The public telecommunication terminal according to claim 3, wherein the memory stores a called party s telephone number the user inputs through the input part when the VoIP mode is performed, and the central processing unit detects the called party's telephone number stored in the memory to transmit it in the form of a data packet when dialing is completed.

5. The public telecommunication terminal according to claim 1, wherein the input part further has a dialing completion button by which completion of dialing the phone number of the called party is selected.

6. The public telecommunication terminal according to claim 5, wherein the central processing unit recognizes that dialing is completed if the dialing completion button of the input part is selected by the user.

7. The public telecommunication terminal according to claim 5, wherein the central processing unit recognizes that dialing is completed when a signal is not inputted from the input part for a predetermined period of time.

8. The public telecommunication terminal according to claim 1, wherein the input part further has a predetermined environment setting button through which the public telecommunication terminal is set to the PSTN mode or VoIP mode.

9. The public telecommunication terminal according to claim 3, wherein the telephone controller comprises:
a microcontroller for managing the telephone controller;
an interface for controlling communication between the verifying means and the microcontroller;
a communication circuit for interfacing communication between the microcontroller and the central processing unit;
a speaking circuit for transmitting/receiving a voice signal inputted/outputted through the handset to/from the telephone network;
relay switches that are switched to transmit a voice signal inputted/outputted through the handset to one of the speaking circuit and the voice signal processing circuit; and
a relay part for controlling the switching operations of the relay switches under the control of the microcontroller.

10. The public telecommunication terminal according to claim 9, wherein the relay part comprises:
a relay for controlling contact states of the relay switches; and
a switching element that is turned on/off according to the control of the microcontroller so as to control flow of constant voltage, to control magnetized state of the relay.

11. The public telecommunication terminal according to claim 1, wherein the central controller confirms if the Internet is available or not and, when the Internet is available, converts the terminal into the VoIP mode, the central controller unit converting the terminal into the PSTN mode when the Internet is not available.

12. A method for controlling a public telecommunication terminal that is connected with a telephone network and the Internet through a modem and performs a PSTN mode using the telephone network and a VoIP mode using the Internet, the method comprising the steps of:
checking the state of the modem when a handset is hooked off, to confirm if connection between the public telecommunication terminal and the Internet is available;
generating and outputting a predetermined dial tone when the connection is available;
when a phone number is dialed, generating and outputting a tone signal corresponding to the dialed number using a predetermined tone signal generating means;
transmitting a packet of the dialed number to the Internet upon the completion of the dialing; and
converting into the PSTN mode when the Internet is not available.

13. The method according to claim 12, further comprising the step of judging if the current mode is the PSTN mode when the connection to the Internet is available, the public telecommunication terminal being converted into the PSTN mode irrespective of whether the connection is available or not when the PSTN mode is set according to a predetermined input signal.

14. The method according to claim 12, wherein dialing is judged to be completed or not according as a dialing completion button is selected or not.

15. The method according to claim 12, wherein it is judged that dialing is completed when there is no input for a predetermined period of time.
